(19) United States
(12) Patent Application Publication
(10) Pub. No.: US 2026/0297994 A1
(43) Pub. Date: Oct. 1, 2026

(54) LOCK FOR A MOTOR VEHICLE

(71) Applicant: Kiekert Aktiengesellschaft, Heiligenhaus (DE)

(72) Inventor: Robert J. Hunt, Davisburg, MI (US)

(73) Assignee: Kiekert Aktiengesellschaft, Heiligenhaus (DE)

(21) Appl. No.: 19/092,025

(22) Filed: Mar. 27, 2025

(51) Int. Cl. E05B 85/24; E05B 83/16; E05B 83/36

(52) U.S. Cl. CPC E05B 85/243; E05B 83/16; E05B 83/36

(57) ABSTRACT

A motor vehicle lock, in particular a side door or tailgate lock, includes a locking mechanism consisting of a rotary latch and at least one pawl, wherein the locking mechanism parts are each rotatably mounted in a lock case by means of a metal spindle, a reinforcing plate, wherein the spindles of the rotary latch and at least one pawl can be connected by means of the reinforcing plate, wherein the reinforcing plate extends at least in part toward the lock case.

### DESCRIPTION

The invention relates to a lock for a motor vehicle, in particular a side door lock, having a locking mechanism consisting of a rotary latch and at least one pawl, wherein the locking mechanism parts are in each case rotatably supported in a lock case by means of a metal spindle, and a reinforcement plate, wherein the spindles of the rotary latch and the at least one pawl can be connected by means of the reinforcement plate.

A lock for a motor vehicle is used as a locking system where components that are movably arranged on the motor vehicle, such as doors, flaps or hoods, must be held securely in position during operation of the motor vehicle. The locking systems are of great importance, since the locking systems, as safety-relevant components, must ensure that the components arranged movably on the motor vehicle are held even in extreme situations. This is easy to understand since, for example, an engine hood that opens unintentionally can put the vehicle driver and/or the occupants in life-threatening situations. On the one hand, the forces acting on the motor vehicle while driving, such as impacts, vibrations or environmental influences, play a role, as do the forces acting on the vehicle in the event of an extreme situation, such as an accident.

In a basic structure of a locking system, a lock holder that can be brought into engagement with the locking system is surrounded by the locking system and the movable component is secured in its position. For this purpose, a rotary latch preferably engages in the lock holder, wherein in the locked or latched position the rotary latch is held in the latched position by means of a pawl. In the case of side doors in particular, two latching positions in the lock are required. There is a pre-latching position and a main latching position in which the side door is completely closed.

In order to withstand the high holding forces in the event of an accident, but also with regard to the dynamic stresses during operation of the motor vehicle, the locking mechanism consisting of a rotary latch and pawl is made of a metal material and mounted on metal spindles, wherein the axles in turn are held in a metal lock plate of the motor vehicle lock.

Such a lock for a motor vehicle is known, for example, from DE 10 2012 214 534A1 . Disclosed is a lock case basically consisting of metal that has a largely flat base plate (lock plate) with one or more side walls. One side wall of the lock case always encloses a right angle with the base plate. As a rule, there are two side walls that are located opposite one another. The lock case then has a U-shape in a sectional view. An entry region in the form of an opening through which the motor vehicle lock can engage with the lock holder is then formed in the base plate and/or a side wall. When reference is made below to a lock case, this should also include a lock plate.

It is also known from the document that the lock has a reinforcing plate, also made of metal, which is used for the additional rotatable fastening of the rotary latch and/or pawl in order to further stabilize the mounting of the locking mechanism. The rotary latch and the pawl are then usually located between the lock case and the reinforcement plate. The use of the reinforcement plate provides maximum stabilization in the locking mechanism, since the rotary spindles of the locking mechanism parts can be supported on both sides by the lock plate and the reinforcement plate. The locking mechanism part spindles, the lock plate and the reinforcing plate form a self-contained structure which can also be referred to as a frame and which can withstand high external forces such as those that occur in an accident.

Since the components of a lock must be regularly protected from dust and water, a lock basically comprises a lock housing with a lock cover for covering one or more components of the lock. The lock housing together with the lock cover is usually made of plastics material for reasons of weight and manufacture. The lock housing and the lock cover can be in one piece or in several pieces. Such a cover can further also serve to protect against burglary.

Another motor vehicle lock with a reinforcement plate is known from DE 10 2012 214 534A1 . The locking mechanism is attached to a base area of a lock case, which is usually made of metal. A lock housing, which is generally made of plastics material and serves as a cover, can be placed on top of these or inserted between them. The subsequent reinforcement plate can be placed directly onto the locking mechanism parts or located above the lock housing. The reinforcement plate is made of metal, wherein the reinforcement plate contributes to rotatable support of components of the locking mechanism such as the rotary latch and pawl. The lock housing can then be closed by a lock cover that is basically made of plastics material.

A side door lock for a motor vehicle has become known from DE 10 2020 131 142A1 , and comprises a locking mechanism consisting of a rotary latch and at least one pawl, and a lock plate, wherein at least the rotary latch and the pawl are in each case rotatably mounted in the lock case by means of a metal spindle and a reinforcing plate, wherein the spindles of the rotary latch and of the at least one pawl can be connected by means of the reinforcing plate. In addition to the simple formation of the connecting web between the locking mechanism part spindles, the reinforcement plate also has extensions that fulfill other functions in the motor vehicle lock. It is disclosed, for example, that the extension can serve as a stop damper for springs or even as a receptacle for buffers. The reinforcement plate can thus assume a multiple function in the motor vehicle lock.

The reinforcement plates for motor vehicle locks known from the prior art have basically proven their worth. A fundamental problem with which the development in the motor vehicle industry and, in particular, in the area of locking systems for motor vehicles is concerned is that sufficient stability must be guaranteed even in extreme situations. Extremely situations occur, for example, when the vehicle is involved in an accident. In particular, the increasing weights of the vehicles due to electromobility can increase the demands on motor vehicle locking systems or motor vehicle locks. Correspondingly amended standards specify new limit values for the load. This is where the invention starts from.

The object of the invention is to provide an improved motor vehicle lock. In particular, it is the object of the invention to provide a motor vehicle lock that can meet increasing requirements and can absorb high loads in multiple mounting orientations in the event of an extreme situation without failure. The motor vehicle lock should be designed in a structurally simple and cost-effective manner.

This object is achieved by claim 1. Advantageous embodiments of the invention are specified in the dependent claims. However, it is pointed out that the clearly stated embodiments are not limiting; instead, any possible variations of the features cited in the description, the patent claims and the drawings can be made.

The object of the invention is achieved in that a motor vehicle lock, in particular a side door or tailgate lock, is provided, comprising a locking mechanism consisting of a rotary latch and at least one pawl, wherein the locking mechanism parts are each rotatably mounted in a lock case by means of a metal spindle, a reinforcing plate, wherein the spindles of the rotary latch and at least one pawl can be connected by means of the reinforcing plate and wherein the reinforcing plate extends at least in part to the lock case. Due to the design of the motor vehicle lock according to the invention and in particular the expanded reinforcing plate, the load on the motor vehicle lock or a tearing resistance can be further increased. In this context, tearing resistance means that the motor vehicle locks are subjected to strict tests before use in the motor vehicle. In particular, the load-bearing capacity in extreme situations, such as for example occur in the event of an accident, can accordingly be tested by a tear test. During the tear test, the lock is brought into engagement with the lock holder, and then the lock and the lock holder are subjected to high loads, in particular tensile loads, which are intended to simulate an accident. The motor vehicle lock and in particular the locking mechanism in the motor vehicle lock must meet the requirements of the automobile manufacturer or the corresponding standards. Due to the extension of the reinforcing plate up to the lock case so that the reinforcing plate comes into engagement with the lock case at least in part, an additional support function can be provided by the reinforcing plate. This additional support function which arises from the interaction of the reinforcing plate and the lock case, increases the tear resistance and can accordingly satisfy the increased or further increasing demands of the heavier vehicles. The configuration of the reinforcement plate and lock case create a box about the rotary latch allowing for cantilevered mountings and tearing resistance in multiple directions.

In many cases, the lock holders are arranged parallel to the rotary latch in the vehicle. If an accident then occurs, the lock holder or the lock holder plate is supported on the vehicle lock and/or on the body of the vehicle. In contrast, with a perpendicular arrangement or an almost perpendicular arrangement of the lock holder in relation to the rotary latch, a sole load can be observed between the lock holder and the rotary latch. In other words, the extreme force of an accident is absorbed solely by the rotary latch and the lock holder. The design of the reinforcing plate up to the lock case according to the invention forms a closed unit which surrounds the rotary latch like a box. The vehicle lock is thus reinforced overall and the rotary latch is held inside the case, which means that much higher loads can be absorbed in different directions.

If the reinforcement plate has at least one opening or recess which can be brought into form-fitting engagement with the lock housing at least in certain areas, this results in an advantageous embodiment of the invention. By shaping of the reinforcement plate with a recess or opening, an adaptation to a geometry or a contour of the lock housing can take place. It is thus possible for the lock plate to support the housing in a form-fitting manner, thereby ensuring stabilized housing parts. The opening can, for example, be joined to a curve in the shape of a circular arc, for example to accommodate a motor or a gear part, and accordingly to support the lock housing.

If reference is made according to the invention to a lock for a motor vehicle, this lock can be used wherever pivotably and/or displaceably mounted components are arranged on the motor vehicle. This means, for example, flaps, hoods, sliding doors, side doors or covers, without restricting the area of use only to these components. The arrangement of the reinforcement plate according to the invention is preferably used in side doors for motor vehicle locks.

The locking mechanism has a rotary latch and at least one pawl. However, locking mechanisms are also known which are equipped with two or more pawls or latching or blocking levers. The reinforcing plate preferably overlaps at least the rotary latch and the pawl directly in engagement with the rotary latch and connects the spindles of the locking mechanism parts to one another. However, in the case of locking mechanisms with more than one pawl, the reinforcement plate can also overlap and stabilize or secure more than two spindles, namely all components engaged with the locking mechanism and the rotary spindles thereof. It is also known that the reinforcement plate is also used, for example, to support gear wheels arranged in the motor vehicle lock.

As described in the introduction, the lock plate, which can also be designed as a lock case, is made of a metallic material, in particular as a stamped part. Reference is made to a lock plate when the metallic reinforcement in the motor vehicle lock has a planar extension. If the lock plate also has a bent portion which, for example, engages around the entry region of the lock holder, this is referred to as a lock case. The lock case can have one, two or more bent portions and can engage around the lock housing at least in certain areas. The term “lock plate” is used below for all of these embodiments. The locking mechanism parts are accommodated in metal spindles on the lock plate, wherein the metal spindles and the reinforcement plate can also be accommodated in a secured position. The locking mechanism parts are thus mounted in the lock case and the reinforcement plate.

If the lock case has at least one bent portion, this results in an advantageous embodiment of the invention. The motor vehicle lock can be used wherever movable components in the motor vehicle have to be securely held in a position. Mention should be made here of hood locks, side door locks, sliding door locks, tailgate locks, but also for example flap locks or locks for backrests, in order to name only examples of fields of use for the motor vehicle lock. A plurality of motor vehicle locks can also be used, for example, in a side door, such as a sliding door. A plurality of locks are used, for example, when large doors have to be closed over the entire length or if the width of the door is used for additional securing on an end of the door opposite the first motor vehicle lock. It can then be advantageous if the lock case is designed to be L-shaped or U-shaped, for example. If the reinforcing plate extends, for example, starting from the locking mechanism part spindles in the direction of the bent portion, the extension of the reinforcing plate and the interaction between the reinforcing plate and the bent edge on the lock case can result in a stable and, for example, form-fit which leads to a stabilization of the vehicle lock as a whole. The reinforcing plate can, for example, rest in part or even completely against the bent portion, and in part surrounding the bent portion.

Furthermore, it has been found to be advantageous if the reinforcing plate covers an edge of the lock case at least in part. An at least partially overlapping of the reinforcing plate beyond the edge of the lock case allows additional stabilization of the reinforcing plate. The reinforcing plate can be supported by the overlap at the edge. The support then leads to an increase in stability. It is also conceivable here that the reinforcing plate projects at least in part beyond the edge of the lock case. This can be advantageous if, for example, there is an opening in the reinforcing plate, and the edge of the lock case protrudes in a form-fit into the reinforcing plate. The interaction between the reinforcing plate and the lock case and the form-fit engagement of the reinforcing plate in the lock case leads on the one hand to increasing the stability of the motor vehicle lock and, on the other hand, can serve as an assembly aid.

A further advantage is achieved if the overlap of the reinforcing plate follows the course of the edge of the lock case at least in part. Depending on the requirements and possible load on the motor vehicle lock, it can be advantageous if the reinforcing plate follows the edge of the lock case. Depending on the overlap of the reinforcing plate and the lock case, a desired stabilization can also be achieved in terms of direction in the motor vehicle lock. The load on a vehicle lock depends at which position and at which orientation the motor vehicle lock is used in the motor vehicle. It is accordingly easily conceivable that a side door lock for e.g. a driver's door can be exposed to other loads than, for example, a secondary lock or a supplementary lock for stabilizing a large sliding door, wherein the additional lock or secondary lock is primarily used to secure the hold or position. Depending on the stress or possible stress of the motor vehicle lock, a stability can be adjustable by the individual design of the reinforcing plate and in particular the interaction of the extension of the reinforcing plate up to an edge of the lock case and/or a partial overlap of the reinforcing plate of the edge region of the lock case.

If the reinforcing plate is connected to the lock case, in particular non-detachably connected to the lock case, a further increase in the tear resistance of the motor vehicle lock can be achieved. In one embodiment variant, the reinforcing plate projects beyond the edge of the lock case and is connected to the edge in a form-fit. In this case, for example, the reinforcing plate can engage in the edge, wherein an elevation at the edge projects beyond the reinforcing plate, so that a reshaping of the edge can be enabled. In other words, the reinforcing plate is inserted into the lock case, wherein elevations are present on the lock case which protrude beyond the reinforcing plate, wherein a reshaping of the part of the lock case projecting beyond the reinforcing plate leads to a non-detachable connection. The reinforcing plate and the lock case then form a unit which is additionally stabilized by the unreleasable connection.

In a continuation of the concept of the invention, at least one bent portion is formed on the reinforcement plate, and the bent portion can be brought into engagement with the lock housing. The bent portion can be arranged directly on the reinforcement plate or can be formed on an extension. The bent portion offers the possibility that the reinforcement plate bears against the housing over a large area. Due to the large contact surface or an enlarged contact surface on the bent portion, a high surface pressure and thus a high force can be transmitted. The stabilizing effect can thus be additionally increased by the bent portion. It is also conceivable that the bent portion can be brought into engagement with the lock housing in a form-fitting manner. The bent portion thus serves to stiffen the reinforcement plate itself and can also provide an enlarged contact surface on the lock housing. A form-fitting integration of the bent portion creates the possibility of achieving additional stabilization of the lock housing. In addition, the bent portion as well as the extensions can have the task of serving as an assembly aid. If, for example, two bent portions are inserted into form-fitting receptacles in the lock housing, the reinforcement plate can be clearly positioned during assembly and the bent portions can thus serve as assembly aids.

In addition, the reinforcement plate can have indentations, which can be achieved, for example, by stamping. Indentations can, for example, be introduced into the reinforcement plate as raised portions, for example by means of deep-drawing. These depressions or indentations can then also be brought into engagement with the lock housing in a form-fitting manner, so that additional contact surfaces can be achieved between the reinforcement plate and the lock housing. In any case, the motor vehicle lock housing can be additionally stabilized by the design of the reinforcement plate according to the invention, whereby an additional stiffening of the lock housing can be achieved with the same number of components. The stabilization by the reinforcement plate can then in turn result in higher stability values for the motor vehicle lock itself and/or there is the possibility of making the lock housing slimmer, i.e. with a smaller number of stiffening ribs. Overall, this results in a stabilizing effect with the same number of components and with the possibility of designing the lock housing to be slimmer and therefore lighter.

If the reinforcing plate has a bent portion at least in part, preferably completely, in the region of an insertion region of a lock holder, an additional stabilization of the motor vehicle lock can be achieved overall. The entry region of the motor vehicle lock is the region in which the lock holder comes into engagement with the rotary latch. When the lock is open, the rotary latch is oriented opposite the lock holder with a fork jaw and in particular with a catch arm in such a way that the rotary latch is rotated by an interaction or relative movement between the lock holder and the motor vehicle lock. The rotary latch is rotated until the rotary latch has fallen into the main detent or pre-detent, that is to say is in engagement with the pawl. For this purpose, the lock case and also the reinforcing plate have to have an opening into which the lock holder can engage. If the reinforcing plate is now circumferentially or at least partially circumferentially provided with a bent portion, the reinforcing plate can additionally experience reinforcement. If the open region of the reinforcing plate acts to reduce stability, the reinforcing plate can additionally be stabilized by the bent portion in the entry region. In particular in the interaction of the extension of the reinforcing plate up to an edge of the entry region of the lock case, which is preferably bent in the entry region, the entry region can be stabilized circumferentially, wherein an additional bent portion of the entry region causes an additional reinforcement of the motor vehicle lock.

The reinforcing plate can have at least one bearing point for a further functional element in the motor vehicle lock. Since the reinforcing plate extends over wide regions of the motor vehicle lock and can preferably also extend up to the edge of the lock case, the reinforcing plate can get an additional function. In this case, the reinforcing plate cannot only store the locking parts, but can also be used for further functional elements such as for example an emergency actuation or as a bearing, for example a closing lever. Overall, the dual function of the reinforcing plate can accordingly dispense with further components in the motor vehicle lock so that structural advantages for the motor vehicle lock also result.

If the reinforcing plate has at least one depression, in particular a reinforcing rib, stabilization of the reinforcing plate can additionally be brought about. The lock case and the reinforcing plate are preferably made of a steel material and are designed at least in part as a deep-drawn component. In particular in the case of a lock case which is used for a tailgate, it is customary for the lock case to have a bent portion circumferentially, i.e. circumferentially around the locking mechanism. In addition, screw-on brackets are then present with which the lock case can be fastened to the motor vehicle. Like the lock case, the reinforcing plate can have a depression, in particular at least in part, a depression as a deformation in the form of a reinforcing rib. A deformation of a steel material results in a partial strength increase of the material, which, due to the deformation of the material and in terms of material technology, leads to dislocation migration in the material, so that a stiffening, i.e. an increase in the hardness of the material results. These deep-drawn regions or indentations in the reinforcing plate can be specifically used manner to additionally stabilize the rotary latch bearing point, for example. However, only ribs can also be formed which then stiffen the reinforcing plate at points or stabilize extensions in particular or additional bearing points in the reinforcing plate.

Overall, the design according to the invention of the elongated reinforcing plate, i.e. extending over large regions of the lock case, can increase the overall stability of the motor vehicle lock. An additional stabilization can be achieved by a corresponding embodiment by means of a form-fit contact with the lock case, a coverage of the reinforcing plate beyond an edge of the lock case and/or bent portions or depressions in the lock plate. The motor vehicle lock can accordingly be adapted to the increased requirements by the embodiment of the reinforcing plate according to the invention.

The invention is explained in more detail below with reference to the accompanying drawings on the basis of a preferred embodiment. However, the principle applies that the exemplary embodiment does not limit the invention, but merely represents one embodiment. The features shown can be implemented individually or in combination with further features of the description as well as the claims—individually or in combination.

### IN THE FIGURES

FIG. 1 shows a three-dimensional view of a motor vehicle lock shown in parts, wherein the motor vehicle lock is shown in a closed position, in particular a main latching position and in engagement with a lock holder, and

FIG. 2 shows a three-dimensional view of the motor vehicle lock according to FIG. 1 from the direction of the arrow II, wherein a mounted emergency actuating lever is additionally shown.

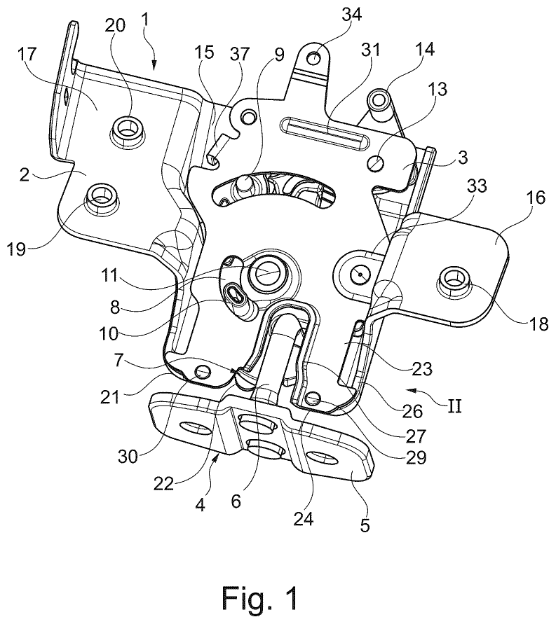

FIG. 1 shows a three-dimensional view of a motor vehicle lock 1 in a plan view of a lock case with an integrated reinforcing plate. A lock holder 4 consisting of a lock holder plate 5 and a lock holder bracket is also visible. The reinforcing plate 3 covers the locking mechanism 7, wherein the lock holder bracket 6 is in engagement with the rotary latch 8 of the locking mechanism 7. A bolt 9, which can be available for example for a closing function, is also fastened to the rotary latch 8. By means of an elevation 10 which can be designed, for example, in one piece with the sheathing of the rotary latch 8, a switching means can, for example, be actuated in order to determine a rotary latch position. Between the lock case 2 and the reinforcing plate 3, the rotary latch 8 is accommodated to pivot about an axis 10 and a pawl 12 to pivot about an axis 13, in a rotatably mounted manner. Furthermore, the spindles 11, 13 of the rotary latch 8 or the pawl 12 can also serve as a further bearing point for, for example, a closing mechanism or an emergency actuation or a release lever. An emergency actuating lever 14 can be seen in FIG. 1.

It can be clearly seen in FIG. 1 that the reinforcing plate 3 extends, starting from the spindles 11, 13, almost over an entire depression 15 in the lock case 2. The reinforcing plate 3 covers almost the entire depression 15 which was molded into the lock case 2 by deforming the lock case 2. The lock case 2 itself has two lateral extensions 16, 17, wherein threads 18, 19, 20 are formed in the extensions 16, 17, which are used as screw openings 18, 19, 20 for fastening the motor vehicle lock 1 in the motor vehicle. In this embodiment of the reinforcing plate 3 according to the invention, the reinforcing plate extends up to an end 21 of the lock case 2, namely up to an entry region 22 of the lock case 2, and extends in part even beyond the end 21 of the lock case 2. The extension 23 of the reinforcing plate 3 projects with one end of the reinforcing plate 24 beyond the bent portion 25 of the lock case 2, wherein the reinforcing plate 3 however rests in part on an edge 26 of the lock case 2 and follows the shape of the edge 26.

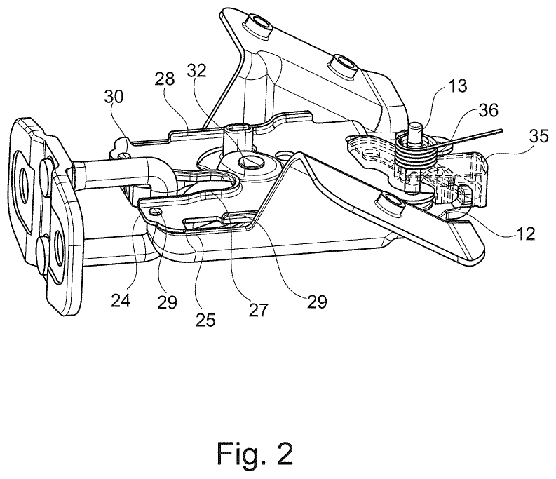

For additional reinforcement, the reinforcing plate 3 has bent portions 27, 28, 29 which can be seen more clearly in FIG. 2. An end 24 of the reinforcing plate 3 projects beyond the lock case 2 and in particular beyond an end 21 of the lock case 2. Deformations 29, 30 are provided in this region which, for example, can be formed in one piece from the lock case 2. However, it is also conceivable according to the invention that here the reinforcing plate 3 is screwed to the lock case 2. However, the lock case 2 preferably has extensions at the end 21 of the lock case 2, which extend through openings in the reinforcing plate 3 and which, after an insertion or placement of the reinforcing plate 3 into the lock case 2, have been subjected to a forming process. It can be said that the reinforcing plate 3 is non-detachably connected to the lock case 2.

For further stabilization of the reinforcing plate, deep-drawn regions 31, 32, 33 are visible in the reinforcing plate 3. An additional stiffening of the reinforcing plate 3 can be achieved by the deep-drawn regions 31, 32, 33. On the one hand, the bearing of the spindle 11 of the rotary latch can accordingly be strengthened and, for example, the additional bearing point 34 can be stabilized by the reinforcing rib 31.

It can be seen in FIGS. 1 and 2 that the reinforcing plate 3 comes into contact with a bent portion 25 on the lock case 2. The contact with the lock case 2, the overlapping of the edge 26 with the non-detachable connection, the bent portions 27, 28, 29 in the reinforcing plate 3 and the contact of the reinforcing plate 3 with the edge 26 overall form means for additional stiffening of the vehicle lock 1 and complement one another in an advantageous manner so that overall, increased tearing forces can be absorbed by means of the vehicle lock 1.

FIG. 2 shows the motor vehicle lock 1 constructed according to the invention in a view from the direction of the arrow Il from FIG. 1. Identical components are provided with the same reference signs. It can be seen in FIG. 2 that the spindle 13 is designed extended, and the spindle 13 additionally bears a release lever 35 in addition to bearing the pawl 12. The release lever 35 is additionally spring-loaded via a leg spring 36 so that a positioning of the release lever and a prestressing of the pawl 12 in the direction of the rotary latch 8 can be enabled. Here, it becomes very apparent that the reinforcing plate 3 comprises a plurality of functions. On the one hand, the reinforcing plate serves to bear and reinforce the locking mechanism 7, and additionally, the reinforcing plate 3 can be available as a bearing point 34 for further functions. For example, a bent portion 37 can also serve for receiving a plastic element, for example a stop buffer, so that further functions can also be transmitted to the reinforcing plate 3.

### LIST OF REFERENCE NUMBERS

1 Motor vehicle lock
2 Lock case
3 Reinforcing plate
4 Lock holder
5 Lock holder plate
6 Lock holder bracket
7 Locking mechanism
8 Rotary latch
9 Bolt
10 Elevation
11, 13 Axis
12 Pawl
14 Emergency actuation lever
15 Recess
16, 17 Extension of the lock case
18, 19, 20 Screw openings
21 End of the lock case
22 Entry region
23 Extension of the reinforcing plate
24 End of the reinforcing plate
25, 27, 28, 29, 37 Bent portion
26 Edge
29,30 Deformation
31, 32, 33 Deep-drawn region, reinforcing rib
34 Bearing point
35 Release lever
36 Leg spring

1. A motor vehicle lock, comprising:
a lock case,
a locking mechanism including a rotary latch and at least one pawl, metal spindles, and
a reinforcing plate,
wherein the rotary latch and the at least one pawl are each rotatably mounted in the lock case by the metal spindles,
wherein the metal spindles for mounting the rotary latch and the at least one pawl are connected by the reinforcing plate,
wherein the reinforcing plate extends at least in part toward the lock case,
wherein the lock case has a first bent portion.
wherein the reinforcing plate has a second bent portion, and
wherein the second bent portion of the reinforcing plate engages the first bent portion of the lock case in a form-fitting engagement.

2. (canceled)

3. The motor vehicle lock according to claim 1, wherein the reinforcing plate covers an edge of the lock case at least in part to define an overlap.

4. The motor vehicle lock according to claim 3, wherein the overlap of the reinforcing plate follows a course of the edge at least in part.

5. The motor vehicle lock according to claim 1, wherein the reinforcing plate is fixedly connected to the lock case.

6. (canceled)

7. The motor vehicle lock according to claim 1, wherein the reinforcing plate has deep-drawn regions.

8. The motor vehicle lock according to claim 1, further comprising a lock holder having an entry region, wherein the reinforcing plate has a third bent portion in the entry region of the lock holder.

9. The motor vehicle lock according to claim 1, wherein the reinforcing plate has at least one bearing point that is configured for a further functional element in the motor vehicle lock.

10. The motor vehicle lock according to claim 1, wherein the reinforcing plate has at least one recess.

11. The motor vehicle lock according to claim 7, wherein the deep-drawn regions are indentations.

12. The motor vehicle lock according to claim 9, wherein the further functional element is an emergency actuator or a closing lever.

13. The motor vehicle lock according to claim 10, wherein the at least one recess is a reinforcing rib.

14. The motor vehicle lock according to claim 1, wherein the lock case and the reinforcing plate are made of a steel material.

15. The motor vehicle lock according to claim 1, wherein the first bent portion of the lock case is circumferentially around the locking mechanism.

16. The motor vehicle lock according to claim 3, wherein reinforcement plate includes an opening and the lock case includes a protrusion at the edge of the lock case that extends through the opening.

17. The motor vehicle lock according to claim 16, wherein the protrusion of the lock case is attached to the reinforcement plate in a form-fitting engagement.
